(19) United States
(12) Patent Application Publication
(10) Pub. No.: US 2011/0004508 A1
(43) Pub. Date: Jan. 6, 2011

(54) METHOD AND SYSTEM OF GENERATING GUIDANCE INFORMATION

(76) Inventors: Shen Huang, Shanghai (CN); Oiang Wang, PuDong (CN); Dan Shen, Shanghai (CN); Xiaodi Zhang, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/497,248

(22) Filed: Jul. 2, 2009

(51) Int. Cl. G06Q 30/00

(52) U.S. Cl. 705/10

(57) ABSTRACT

One embodiment provides a system for generating questions related to product aspects. The system may comprise: a product review analyzer to extract product values associated with the products from product reviews, in which the product values may include product categories, product aspects and product aspect evaluations; a product review summary builder to build product review summaries based on the extracted product values associated with the products; and a question generator to generate a set of questions regarding the product aspects based on the product review summaries.

### TECHNICAL FIELD

The present application relates to methods and systems for generating a recommendation of a list of products over a network.

### BACKGROUND

With the development of computer and network related technologies, more users or customers communicate over networks and participate electronic commerce (e-commerce) activities. For example, users or customers may try to find and/or purchase items (e.g., products or services) via networks (e.g., the Internet). In many situations, it is however a time consuming task for users or customers to find items that meet their demand.

### BRIEF DESCRIPTION OF THE DRAWINGS

Some embodiments are illustrated by way of examples and not limitation in the figures of the accompanying drawings in which:

FIG. 1A is a network diagram illustrating a system having a client-server architecture in accordance with an embodiment.

FIG. 1B is a detailed network diagram illustrating a system having a client-server architecture in accordance with an embodiment.

FIG. 2 is a block diagram illustrating multiple e-commerce shopping guidance modules (or devices) in accordance with an embodiment.

FIG. 3 is a high level entity-relationship diagram illustrating various tables maintained in a database in accordance with an embodiment.

FIG. 4 is a flowchart illustrating a method of providing e-commerce shopping guidance to a customer via a network in accordance with an embodiment.

FIG. 5 is a block diagram illustrating a machine in the example form of a computer system, within which a set of sequence of instructions for causing the machine to perform any one of the methodologies discussed herein may be executed.

### DETAILED DESCRIPTION

Example methods and systems to provide e-commerce shopping guidance to a customer via a network are described. In the following description, for purposes of explanation, numerous specific details are set forth in order to provide a thorough understanding of example embodiments. It will be evident, however, to one skilled in the art that the present application may be practiced without these specific details.

The term “product” used in the following description denotes both “products” and “services,” which can be found and/or purchased.

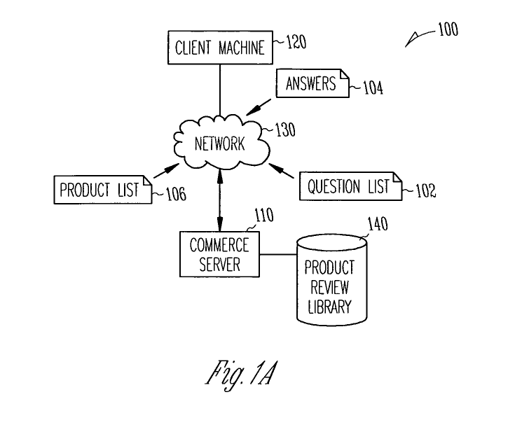

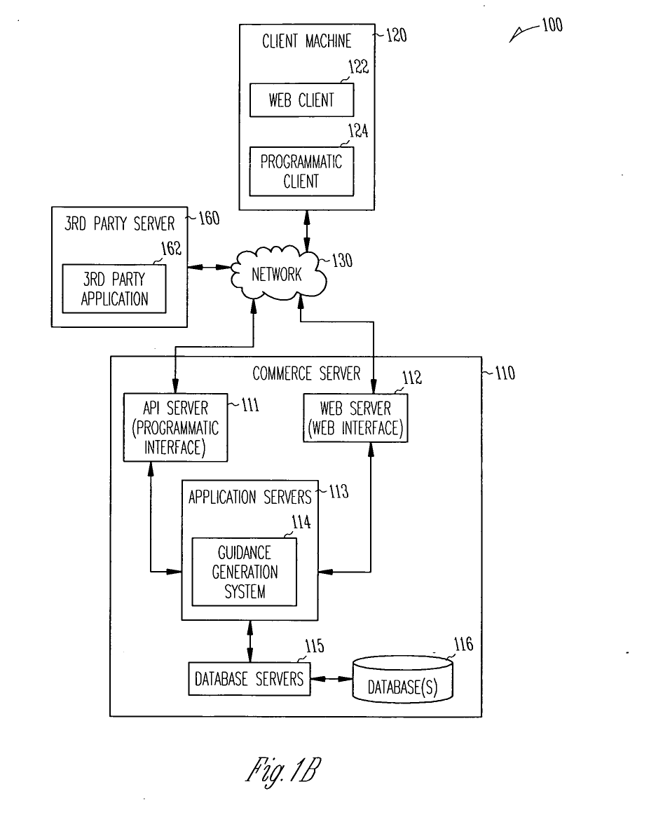

FIG. 1A is a high level network diagram depicting a system having a client-server architecture in accordance with an embodiment of the present application. As show in FIG. 1A, an e-commerce shopping guidance system 100 includes a commerce server 110 and at least one client machine (e.g., a PC computer) 120, which are connected via a network (e.g., the Internet) 130. The commerce server 110 may get access to a product review library 140, which collects and stores a huge number of product reviews related to a large number of products.

A buyer or customer may get access to the client machine 120, and then interact with the commerce server 110 via the network 130. When interacting with the commerce server 110, a customer may, for example, initially indicate his/her interest by entering a product category (e.g., camera) via an input device (e.g., a keyboard) of the client machine 120. In response to the entered product category, the commerce server 110 may provide a list of questions 102 regarding product aspects (e.g., appearance, size, photo quality or battery life) of the entered product category. The questions may be generated based on the product reviews, collected in the product review library 140, on the products (e.g., different brands and/or types of cameras) belonging to the entered product category (e.g., camera). For example, if a product review indicates positive comments on one or more product aspects of a particular product (e.g., beautiful appearance and compact size of a particular brand camera) based on training data generated as described further below, the commerce server 110 may generate questions 102 such as “Do you prefer a camera with a beautiful appearance?” and “Do you prefer a camera with a compact size?”

The commerce server 110 may then provide the customer with the questions 102, which can be used to guide the customer to find products that meet his/her demand.

In some embodiments, answers 104 to the questions 102, provided by a customer, can be used to refine product search results by matching the criteria indicated by the customer in the answers 104) and the product review summaries (which are derived from the product review library 140 and will be explained in more detail later). In this way, a list of proposed products 106 may be presented to the customer via the client machine 120.

### Platform Architecture

FIG. 1B is a detailed network diagram depicting a client-server system 100 in accordance with an embodiment of the application. An example server system, configured as a network-based commerce server 110, provides server-side functionality, via a network 130 (e.g., the Internet or Wide Area Network (WAN)) to one or more client machines 120. FIG. 1B illustrates, for example, a web client 122 (e.g., a browser), and a programmatic client 124 executing on a respective client machine 120.

An Application Program Interface (API) server 111 and a web server 112 are coupled to, and provide programmatic and web interfaces respectively to, one or more application servers 113. The application servers 113 include a guidance generation system 114. The application servers 113 are, as shown, coupled to one or more database servers 115 that facilitate access to one or more databases 116.

The guidance generation system 114 may provide a number of e-commerce shopping guidance functions and services that may help customers to find products meeting their demands. While the guidance generation system 114 are shown in FIG. 1B to form part of the networked commerce server 110, it will be appreciated that, in alternative embodiments, the guidance generation system 114 may form part of an e-commerce shopping guidance service that is separate and distinct from the networked system.

While the system 100 shown in FIGS. 1A and 1B employs a client-server architecture, the present application is not limited to such architecture, and could equally well find application in a distributed or a peer-to-peer architecture system for example. The guidance generation system 114 could also be implemented as standalone software programs, hardware or devices, which do not necessarily have networking capabilities.

The web client 122 may access guidance generation system 114 via the web interface supported by the web server 112. Similarly, the programmatic client 124 may access the various services and functions provided by the guidance generation system 114 via the programmatic interface provided by the API server 111.

FIG. 1B also illustrates a third party application 162, executing on a third party server machine 160, as having programmatic access to the networked commerce server system 110 via the programmatic interface provided by the API server 111. The third party application 162 may utilize information retrieved from the networked commerce server system 110 and support features or functions on a website hosted by the third party. The third party server machine 160 may provide one or more e-commerce shopping guidance functions or services that are supported by the relevant applications and/or devices of the networked commerce server system 110, for example. The third party server machine 160 may also provide data resources (e.g., a product review library, product review summaries, training data), which may be provided to and utilized by certain modules in the guidance generation system 114.

### Guidance Generation System

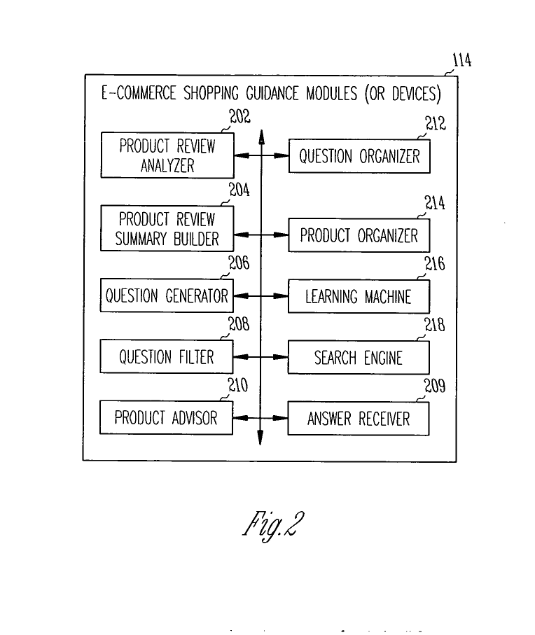

FIG. 2 is a block diagram illustrating e-commerce shopping guidance modules (or devices) 114 in accordance with one example embodiment. The guidance generation system 114 may be hosted on a dedicated server machine or on shared server machines that are communicatively coupled to enable communications between these server machines. Modules (or devices) of the guidance generation system 114 themselves are communicatively coupled (e.g., via appropriate interfaces) to each other and to various data sources, so as to allow information to be passed between the modules (or devices) of the guidance generation system 114 or so as to allow the modules of the guidance generation system 114 to share and access common data. In some embodiments, the modules of the guidance generation system 114 may be coupled to a bus line for example and thus may communicate each other. The modules of the guidance generation system 114 may furthermore access one or more databases 116 via the database server 115.

The modules of the guidance generation system 114 may provide a number of functions and/or services to users or customers of the network-based commerce server system 110. In some embodiments, the guidance generation system 114 may include, but are not limited to, a product review analyzer 202, a product review summary builder 204, a question generator 206, a question filter 208, an answer receiver 209, a product advisor 210, a question organizer 212 and a product organizer 214. These modules of the guidance generation system 114 may be implemented in software, hardware, or as a combination of software and hardware. In one embodiment, the product review library 140 (as show in FIG. 1A) may collect a number of product reviews associated with products and may be stored in the database 116 (as shown in FIG. 1B).

In some embodiments, the product review analyzer 202 may, by analyzing the product reviews stored in the product review library 140 using machine learning technique, extract product values associated with the products from the product reviews stored in the product review library 140 of FIG. 1A. The product values may include product categories (e.g., camera), product aspects (e.g., photo quality, appearance, size or battery life) and product aspect evaluations (e.g., poor, fair, good or excellent), for example.

In some embodiments, the product review analyzer 202 may utilize a learning machine 216 to analyze the product reviews with training data and to thus extract product values associated with the products. The training data may be stored in the database 116. The term “training data” denotes a set of known and predictable data that may be used to configure the learning machine 216 to identify that a comment associated with a product review stored in the product review library 140 is either a positive comment or a negative comment. As such, training data is needed and the learning machine 216 will learn from the training data as explained further below.

In some embodiments, the training data may include many labeled samples related to product aspect tasks and sentiment tasks to enable the learning machine to extract the product aspects and the product aspect evaluations associated with the products. With respect to “training data,” some examples (or samples) may be provided to the learning machine 216. The learning machine 216 processes each sample (here, the comments regarding a product) and the associated “positive” or “negative” identification. Each product aspect task may include an input of a product review message, and an output (or label) indicating a product aspect extracted from the input product review message. Each sentiment task may include an input product review message and an output (or label) evaluating the product aspect obtained from the product aspect task. The label of the product aspect (e.g., “Photo Quality”) and the label of the product aspect evaluation (e.g., “Positive”) are stored in a table and can be used as training data, utilizing a machine learning algorithm. An example product aspect task and sentiment task associated with a camera are illustrated as follows:

### Product Aspect Task:

Input: The pictures are crystal clear and the videos you can record are fantastic.
Output: Photo quality

### Sentiment Task:

Input: The pictures are crystal clear and the videos you can record are fantastic.
Output: Positive
   After training, the learning machine 216 can take advantage of the training data and automatically predict “Photo quality” and “Positive” if it sees a product review similar to “The pictures are crystal clear and the videos you can record are fantastic,” for example.

In some embodiments, the product review summary builder 204 may build product review summaries based on and including the extracted product values associated with the products. In some embodiments, the product review summaries may be stored in a product review summary table 306, which may contain a record for each product review, and may include fields to store a product review summary identifier, a product identifier, a product name (e.g., Nikon D80), one or more product aspect identifiers, one or more product aspect names (e.g., photo quality, appearance, size or battery life), and one or more product aspect evaluations (e.g., poor, fair, good or excellent), as explained further below.

In some embodiments, the question generator 206 may generate a set of questions regarding the product aspects based on the product review summaries. Each question may be associated with a product aspect of a product category. For example, if a number of reviews associated with a certain product (e.g., Nikon D80) and stored in the product review library 140 include certain text such as “wonderful”, “image” and “quality”, the question generator 206 may automatically detect these comments and generate a question, such as “Do you prefer a camera with high performance and high photo quality?”

In some embodiments, the question filter 208 may select a predetermined amount (e.g., 5) of filtered questions 102 from the set of generated questions based on an input from the customer. For example, the customer may enter a product category (e.g., camera), then the question filter 208 will filter or limit to include only questions regarding cameras. The filtered questions 102 may be provided to the client machine 120 of FIG. 1B and be presented to the customer via a display for example. The answer receiver 209 may receive answers provided from the customer.

In some embodiments, the filtered questions 102 may be ranked (or sorted), by the question organizer 212, as a function of aspect review frequencies and data indicating positive aspect evaluations associated with the product aspects. In many situations, the selection of a list of questions and the order (or rank) of the list of questions are important. Machine learning techniques may be used to summarize a huge number of reviews and to identify the product aspects that are considered important according to the reviews. E.g., the frequency with which a certain term appears in reviews associated with a product may be indicative of the importance of the associated product feature. For example, if the term “color” appears frequently in reviews associated with a certain camera product, a question such as “Do you want a camera with beautiful color?” may be generated and ranked higher in the list of questions, and provided to the client machine 120.

In some embodiments, the product advisor 210 may select, by using a search engine 218, a list of proposed products (e.g., from a product database) based on the answers 104 provided by the customer responsive to the filtered questions 102. The product advisor 210 may provide the proposed products to the client machine 120.

In some embodiments, the product organizer 214 may rank items in the list of proposed products 106 as a function of the aspect evaluations that match an interest expressed in the answers 104 from the customer. The product organizer 214 may use a search engine 218 to find the matches between aspects of a product that were indicated by a customer as desirable (e.g., indicated in answers from the customer) and the product aspect evaluations (e.g., from the product review summaries).

In some embodiments, the formula behind the above match process can be described as follows:

$${p}_{j} = {\sum }_{i = 1}^{n} {w}_{i} \times {s}_{i}$$

where n is the total number of produced aspects (i.e., product questions), wᵢ is the weight for ith product aspect based on the answer of the customer. For example, the more frequent a product aspect is mentioned in product reviews, the higher the weight wᵢ is. Sᵢ is the score on ith product aspect of the j th product. Thus, Pⱼ reflects customers' evaluation and feedback on the j th product based on the product review summaries. The higher the value of Pⱼ of the j th product is, the higher the j th product will be ranked and presented in the proposed product list.

### Data Structures

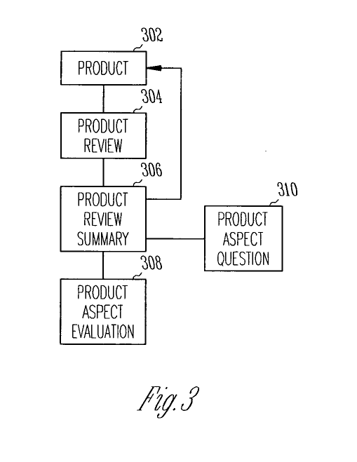

FIG. 3 is a high-level entity-relationship diagram, illustrating various tables 300 that may be maintained within the databases 116 as shown in FIG. 1A, and that are utilized by and support the e-commerce shopping guidance modules (or devices) 114 as shown in FIG. 1B. The various tables 300 may include, but not limited to, a product table 302, a product review table 304, a product review summary table 306, a product aspect evaluation table 308, and a product aspect question table 310.

The product table 302 may contain a record for each product, which has been reviewed by at least one of the product reviews stored in the product review library 140. The record may include a product identifier, a product category, a product name, and a product description etc.

The product review table 304 may contain a record for each product review, and may include a product review identifier, a product identifier, a product review title, a product review author, a product review time, and a product review comment etc. The product review comment may be a text of a variable length. For example, a record storing a product review for a camera (e.g., Nikon D80) by an author on Apr. 23, 2009 reads, . . . . The pictures are crystal clear and the videos you can record arefantastic . . . .

The product review summary table 306 may contain a record for each product review, and may include fields of a product review summary identifier, a product identifier, a product name (e.g., Nikon D80), one or more product aspect identifiers, one or more product aspect names (e.g., photo quality, appearance, size or battery life), and one or more product aspect evaluations (e.g., poor, fair, good or excellent). Each product review summary record of the product review summary table 306 may correspond to each product review record of the product review table 304. The product aspect evaluation related data of the product review summary table 306 is extracted from the product review comment (for example, a variable length of text) related data of the product review table 304 by using machine learning technique and training data as discussed above. For example, one record of the product review summary table 306 for a camera (e.g., Nikon D80) may include many product aspect values (such as “photo quality”, “appearance”, “size” and “battery life”) and corresponding product aspect evaluation values (e.g., “excellent”, “excellent”, “good” and “fair”).

The product aspect evaluation table 308 may contain a record for each product review, and may include a product review summary identifier, a product identifier, one or more product aspect identifiers, one or more product aspect names, and one or more product aspect evaluations. The product aspect evaluations of the product aspect evaluation table 308 for the products may be based on the product aspect evaluations of the product review summary table 306.

The product aspect question table 310 may contain a record for each question, and may include a question identifier, a product aspect identifier, and a product aspect name. Based on an answer 104 from the customer to the question 102, the product advisor 210 may select a list of products 106 by searching the product review summary table 306 and the product table 302, and present the selected products 106 to the customer.

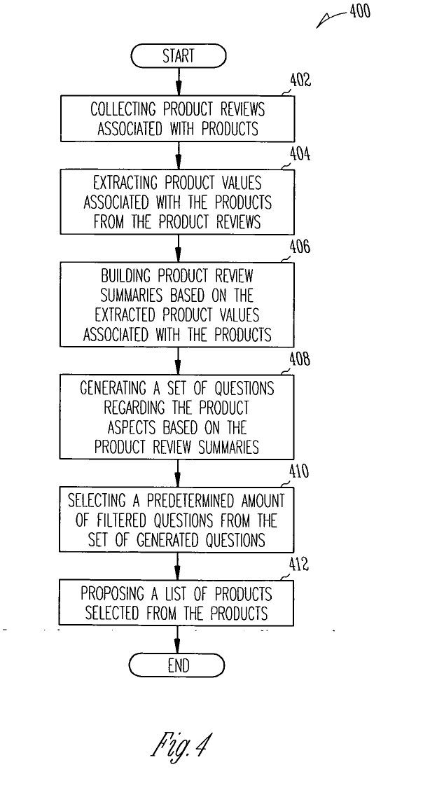

FIG. 4 is a flowchart illustrating a method 400 of providing e-commerce shopping guidance to a customer via a network in accordance with an embodiment of the present application.

At operation 402, the product review library 140 may collect a number of product reviews associated with products.

At operation 404, the product review analyzer 202 may extract product values associated with the products from the product reviews by analyzing the product reviews with training data. The product values may include product categories (e.g., camera), product aspects (e.g., appearance, size, photo quality or battery life) and product aspect evaluations (e.g., poor, fair, good or excellent).

At operation 406, the product review summary builder 204 may build product review summaries based on the extracted product values associated with the products. For example, one record of the product review summary for a camera (e.g., Nikon D80) may include many product aspect values (such as “photo quality”, “appearance”, “size” and “battery life”) and corresponding product aspect evaluation values (e.g., “excellent”, “excellent”, “good” and “fair”).

At operation 408, the question generator 206 may generate a set of questions regarding the product aspects based on the product review summaries. Each generated question is associated with each product aspect of each product category. The generated questions may be “yes-or-no” questions, such as, for example, “Do you prefer a camera with high performance at photo quality? Yes or No?” The generated questions may also be multiple choice questions, such as, for example,

“Do you consider high photo quality to be an important feature of a camera?”
a) “highly considered” b) “considered” c) “don't care”
“Do you want a camera with compact size?
a) “highly considered” b) “considered” c) “don't care”

At operation 410, the question filter 208 may select a predetermined amount (e.g., 5) of filtered questions from the set of generated questions based on an input from the customer. The input from the customer may be a product category (e.g., camera). The filtered questions may be provided to the client machine 120. In some embodiments, the filtered questions are ranked, by the question organizer 212, as a function of aspect review frequencies and data indicating positive aspect evaluations associated with the product aspects, and are presented to the customer via a display.

At operation 412, the product advisor 210 may select a list of proposed products from the product table 302 based on answers to the filtered questions by using a search engine 218. For example, the customer may answer “Yes” to the question “Do you prefer a camera with high photo quality?” Once the client machine 120 communicates the answers to the guidance generation system 114, the product advisor 210 may match the customer's interests (indicated in the answers to the questions) with the product review summaries of different products. For instance, if the client machine 120 communicates to the guidance generation system 114 that a user indicated high preference for “photo quality” and no preference for “size” regarding a camera, the guidance generation system 114 may identify product listings of professional cameras (e.g., Nikon D80) that are characterized by high photo quality. The identified listings may be provided to the client machine 120 as listings ranked with the high ranking and presented at the top of the results list. The proposed products may be presented to the customer via a display (not shown).

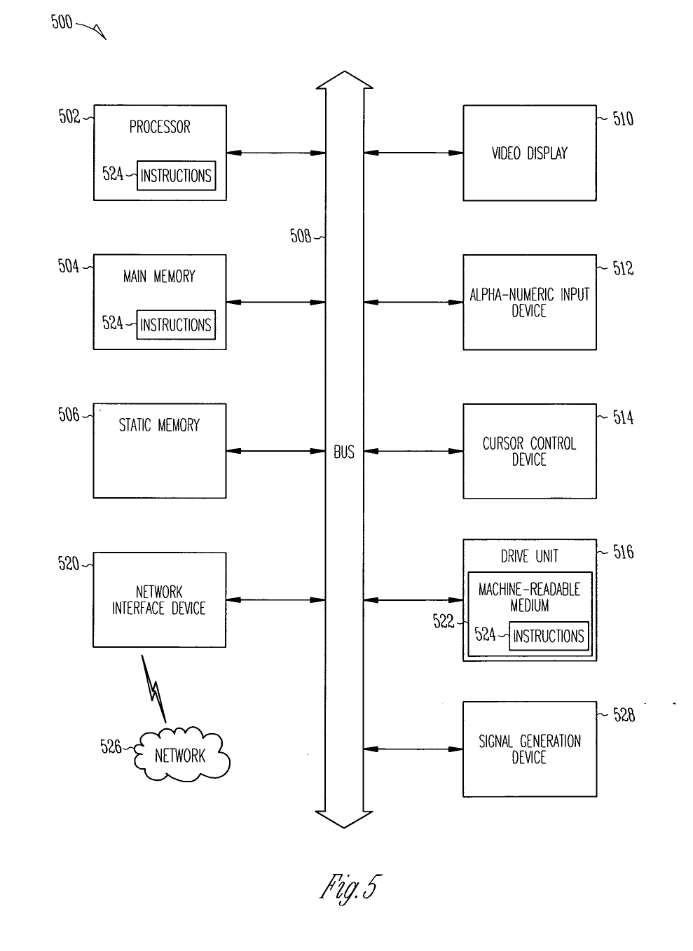

FIG. 5 is a block diagram illustrating a machine in the example form of a computer system 500, within which a set of sequence of instructions for causing the machine to perform any one of the methodologies discussed herein may be executed. In alternative embodiments, the machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein. The example computer system 800 includes a processor 502 (e.g., a central processing unit (CPU) a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520. While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, methods and systems for providing e-commerce shopping guidance to a customer via networks have been described. Although the present application has been described with reference to specific embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system comprising:
a product review analyzer to extract product values associated with products from product reviews, the product values including product categories, product aspects and product aspect evaluations;
a product review summary builder to build product review summaries based on the extracted product values associated with the products; and
a question generator to generate a set of questions regarding the product aspects based on the product review summaries, wherein each question is associated with each product aspect of each product category.

2. The system of claim 1, wherein the product review analyzer includes a learning machine, the learning machine to analyze the product review summaries by utilizing training data to extract the product values associated with the products.

3. The system of claim 2, wherein the training data includes labeled samples related to product aspect tasks and sentiment tasks to enable the learning machine to extract the product aspects and the product aspect evaluations associated with the products.

4. The system of claim 1, further comprising a question filter to select a predetermined amount of filtered questions from the set of generated questions based on an input from the customer, wherein the predetermined amount of filtered questions are presented to the customer via a display.

5. The system of claim 4, further comprising a question organizer to rank the filtered questions as a function of aspect review frequencies and data indicating positive aspect evaluations associated with each product aspect of each product category.

6. The system of claim 1, further comprising a product review library to collect the product reviews associated with the products.

7. A system, comprising:
a question generator to generate a set of questions regarding product aspects based on product review summaries related to products, wherein the products are associated with product values, the product values including product categories, product aspects and product aspect evaluations, and wherein each question is associated with each product aspect of each product category;
a question filter to select a predetermined amount of filtered questions from the set of generated questions based on an input from the customer;
a question organizer to organize the filtered questions to be presented to the customer via a display;
an answer receiver to receive answers to the filtered questions; and
a product advisor to propose a list of products from the products based on the answers to the filtered questions.

8. The system of claim 7, wherein the filtered questions are ranked, by the question organizer, as a function of aspect review frequencies and data indicating positive aspect evaluations associated with the product aspects.

9. The system of claim 7, wherein the list of proposed products are ranked, by the product organizer, as a function of the aspect evaluations that match an interest expressed in the answer from the customer.

10. The system of claim 7, further comprising a product review analyzer to extract the product values of the products from the product reviews by analyzing the product reviews with training data.

11. The system of claim 10, wherein the training data includes labeled samples related to product aspect tasks and sentiment tasks to enable the learning machine to extract the product aspects and the product aspect evaluations associated with the products.

12. The system of claim 7, further comprising a product review summary builder to build the product review summaries based on the extracted product values associated with the products.

13. A computer implemented method comprising:
collecting, in a product review library, product reviews associated with products;
extracting, via a product review analyzer, product values associated with the products by analyzing the product reviews, the product values including product categories, product aspects and product aspect evaluations;
building, at a product review summary builder, product review summaries based on the extracted product values associated with the products; and
generating, at a question generator, at least one question associated with one of the product aspects based on the product review summaries.

14. The method of claim 13, wherein the product review analyzer analyzes the product reviews by a learning machine to extract product values associated with the products.

15. The method of claim 14, wherein training data is used by the learning machine to extract the product aspects and the product aspect evaluations associated with the products, the training data includes labeled samples related to product aspect tasks and sentiment tasks.

16. The method of claim 13, further comprising:
selecting, by a question filter, a predetermined number of filtered questions from the set of questions based on an input from the customer to present to the customer via a display, wherein the filtered questions are ranked, by a question organizer, as a function of aspect review frequencies and positive aspect evaluations associated with the product aspects.

17. The method of claim 16, further comprising:
proposing, by a product advisor, a list of products selected from the products based on an answer to the one or more the filtered questions to present to the customer via the display, wherein the proposed products are ranked, by a product organizer, as a function of the aspect evaluations that match an interest expressed in the answer from the customer.

18. A machine-readable medium comprising instructions, which when executed by one or more processors, perform the following operations:
collecting, in a product review library, product reviews associated with products;
extracting, via a product review analyzer, product values associated with the products by analyzing the product reviews, the product values including product categories, product aspects and product aspect evaluations;
building, by a product review summary builder, product review summaries based on the extracted product values associated with the products; and
generating, by a question generator, a set of questions associated with the product aspects based on the product review summaries, wherein each question is associated with each product aspect.

19. The machine-readable medium of claim 18, wherein the instructions, when executed by the one or more processors, further perform the following operation:
selecting, by a question filter, a predetermined number of filtered questions from the set of questions based on an input from the customer to present to the customer via a display, wherein the filtered questions are ranked, by a question organizer, as a function of aspect review frequencies and positive aspect evaluations associated with the product aspects.

20. The machine-readable medium of claim 18, wherein the instructions, when executed by the one or more processors, further perform the following operation:
proposing, by a product advisor, a list of products selected from the products based on an answer to the one or more the filtered questions to present to the customer via the display, wherein the proposed products are ranked, by a product organizer, as a function of the aspect evaluations that match an interest expressed in the answer from the customer.
